(19) United States
(12) Patent Application Publication
(10) Pub. No.: US 2008/0022138 A1
(43) Pub. Date: Jan. 24, 2008

(54) COMPUTER SECURITY SYSTEM

(75) Inventors: CHUNG-CHI HUANG, Tu-Cheng (TW); Guang-Dong Yuan, Shenzhen (CN); Jin-Bo Wang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,775

(22) Filed: Sep. 23, 2006

(30) Foreign Application Priority Data
Jul. 21, 2006 (CN) 200610061752.4

(51) Int. Cl. G06F 1/00

(52) U.S. Cl. 713/300

(57) ABSTRACT

A computer security system includes a motherboard, a power supply, and a lock. The power supply supplies power to the motherboard via a power supply circuit. The lock includes a key, and the lock is electrically connected between the motherboard and the power supply. The key controls open and closed states of the power supply circuit.

### FIELD OF THE INVENTION

The present invention relates to secure systems, and more particularly to a computer security system having improved security features.

### DESCRIPTION OF THE RELATED ART

In today's information age, a user is generally required to execute or pass some form of a security step, such as entering a private identification code or password, to access a company system.

As computer stored information and/or applications become more sensitive or valuable, greater security measures are desired to verify the identity and legitimacy of the user before allowing access to the computer system. The use of a password alone, however, has become less reliable in authenticating a legitimate user. The reduced reliability of using the password alone has been due to a computer hacker's ability to locate, copy, or electronically identify or track the required password using specialized software programs. Accordingly, the use of a password alone to authenticate users for access to computer systems has not been very reliable.

What is desired, therefore, is a computer security system having improved security features.

### SUMMARY OF THE INVENTION

In one preferred embodiment, a computer security system includes a motherboard, a power supply, and a lock. The power supply supplies power to the motherboard via a power supply circuit. The lock includes a key, and the lock is electrically connected between the motherboard and the power supply. The key controls open and closed states of the power supply circuit.

Other advantages and novel features will become more apparent from the following detailed description of preferred embodiments when taken in conjunction with the accompanying drawings, in which:

### BRIEF DESCRIPTION OF THE DRAWINGS

FIG. 1 is an isometric, schematic view of a computer security system in accordance with a preferred embodiment of the present invention; and

FIG. 2 is a schematic side view of the computer security system of FIG. 1.

### DETAILED DESCRIPTION OF THE INVENTION

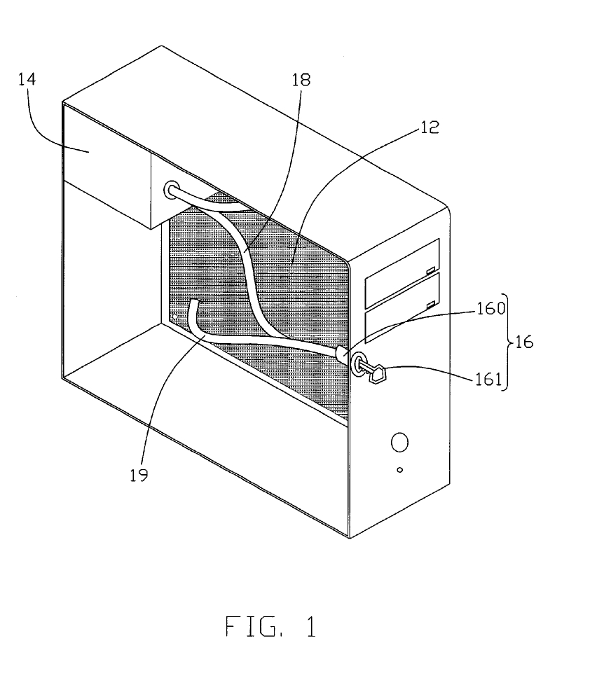

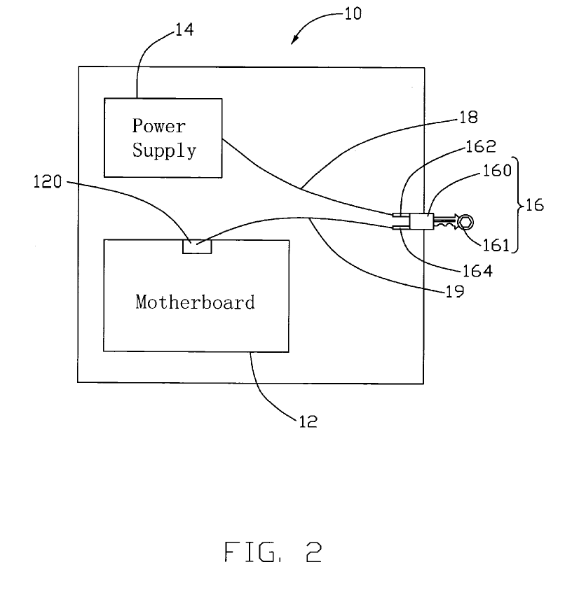

Referring to FIGS. 1 and 2, a computer security system of a preferred embodiment of the present invention includes a motherboard 12, a power supply 14, and a lock 16. The lock 16 is a mechanical keyed lock configured for use as a switch. The lock 16 includes a switch portion 160, and a key 161. The switch portion 160 includes a first terminal 162, and a second terminal 164. The first terminal 162 is electrically connected to the power supply 14 via an electrical wire 18. The second terminal 164 is electrically connected to an electrical source module 120 of the motherboard 12 via an electrical wire 19.

The lock 16 is chosen according to a certain value of voltage provided by the power supply 14. The lock 16 further includes a mechanical member (not shown) to control open/closed states of the switch portion 160. The key 161 is rotated to open or close a power supply circuit formed by the electrical wires 18, 19, the first terminal 162, and the second terminal 164. In the preferred embodiment, the lock 16 is mounted on a front panel of the computer for easily operation. The lock 16 may alternatively be mounted separately according to preference.

In use, before the user leaves a computer, the key 161 of the lock 16 is rotated to open the power supply circuit. Then input power of the motherboard 12 of the computer is shut off, thus providing another level of security beyond a password. When the user returns, the key 161 is used again for closing the power supply circuit. Therefore, the power supply 14 provides the power needed by the motherboard 12, and the computer works normally after other optional security steps are satisfied such as inputting a password of the computer thereafter.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A computer security system comprising:
a motherboard of a computer;
a power supply configured for providing power to the motherboard via a power supply circuit; and
a lock electrically connected in series with the power supply circuit between the motherboard and the power supply to control power to the motherboard, the lock being configured for controlling open/closed states of the power supply circuit.

2. The computer security system as claimed in claim 1, wherein the lock is a mechanical keyed lock configured for use as a switch.

3. The computer security system as claimed in claim 2, wherein the lock further comprises a switch portion, the switch portion comprises a first terminal, and a second terminal; the first terminal and the second terminal are respectively connected to the motherboard and the power supply via the power supply circuit; a key controls open or closed states of the power supply circuit by opening or closing a connection between the first terminal and the second terminal.
